(19) United States
(12) Patent Application Publication
(10) Pub. No.: US 2024/0116690 A1
(43) Pub. Date: Apr. 11, 2024

(54) FLEXIBLE TANK

(71) Applicant: KYUNGDONG NAVIEN CO., LTD., Pyeongtaek-si (KR)

(72) Inventors: Young Jo Lim, Seoul (KR); Soo Young Lee, Seoul (KR)

(21) Appl. No.: 18/476,755

(22) Filed: Sep. 28, 2023

(30) Foreign Application Priority Data
Oct. 6, 2022 (KR) 10-2022-0128047

(51) Int. Cl. B65D 77/06; B65D 77/22

(52) U.S. Cl. CPC B65D 77/062; B65D 77/22; C02F 1/441

(57) ABSTRACT

A flexible tank according to the present invention includes an inner tank having an inner space and having elasticity, an outer tank in which the inner tank is disposed, and a passage part passing through the inner tank in a reference direction, and having an outer end disposed outside the inner tank and an inner end disposed in the inner space so that the inner space communicates with the outside of the inner tank.

### CROSS-REFERENCE TO RELATED APPLICATIONS

This application claims the priority of Korean Patent Application No. 10-2022-0128047 filed on Oct. 6, 2022, in the Korean Intellectual Property Office, the disclosure of which is incorporated herein by reference.

### BACKGROUND OF THE INVENTION

### Field of the Invention

The present invention relates to a flexible tank capable of being used as a flushing tank of a water purifier.

### Description of the Related Art

Water purifiers are devices for purifying raw water such as tap water, and supply drinking water containing only materials beneficial to human bodies by removing heavy metals or other harmful substances contained in the raw water on the basis of a water purification method including processes such as precipitation, filtration, and disinfection.

These water purifiers include various filters in order to purify the raw water. According to the functions, these filters are classified into a sediment filter, an activated carbon (AC) filter, a hollow fiber UF membrane filter, a RO membrane filter, and the like.

The filters as above are sequentially connected to constitute a filter system. While the raw water passes through the filter system, the heavy metals or harmful substances contained in the raw water are removed, and the raw water is purified.

Reverse osmosis-type water purifiers perform water purification by applying an external pressure to liquid with a higher concentration so that the liquid is forced to flow in a direction opposite to a direction in which osmosis occurs, i.e., from a higher concentration side to a lower concentration side. The reverse osmosis-type water purifiers require a flushing process of passing water through filters before the fundamental purification is performed using the filters. As a sufficient amount of water is necessary to achieve flushing, a direct water tank, a purified water tank, or the like may be used to supply the water for flushing, or a method of providing a separate flushing tank may be used.

Water needs to be introduced and stored in the flushing tank, and then discharged from the flushing tank for flushing. Thus, for the inflow and outflow of water, not only an inlet and an outlet for water but also an inlet and an outlet for air need to be disposed in the flushing tank. However, as the inlet and the outlet for air are further disposed, and thus the flushing tank is not sealed, it is difficult to prevent the water from leaking or external dust from entering the flushing tank to contaminate the stored water.

### SUMMARY OF THE INVENTION

The present invention has been devised to solve the limitations as above, and an aspect of the present invention provides a flushing tank having a sealed structure.

According to an aspect of the present invention, there is provided a flexible tank including an inner tank having an inner space and having elasticity, an outer tank in which the inner tank is disposed, and a passage part passing through the inner tank in a reference direction, and having an outer end disposed outside the inner tank and an inner end disposed in the inner space so that the inner space communicates with the outside of the inner tank.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a flexible tank according to an embodiment of the present invention;

FIG. 2 is an exploded perspective view of a flexible tank according to an embodiment of the present invention;

FIG. 3 is a longitudinal cross-sectional view of a flexible tank according to an embodiment of the present invention;

FIG. 4 is an enlarged detailed view of a portion in FIG. 3;

FIG. 5 is a perspective view of a clamp and a passage part according to an embodiment of the present invention;

FIG. 6 is an exploded perspective view of a passage part according to an embodiment of the present invention;

FIG. 7 is a view illustrating an upper portion of a flexible tank so as to expose a longitudinal section of the flexible tank according to an embodiment of the present invention;

FIG. 8 is an enlarged detailed view of another portion in FIG. 3; and

FIG. 9 is an enlarged detailed view of still another portion in FIG. 3.

### DETAILED DESCRIPTION OF THE PREFERRED EMBODIMENT

Hereinafter, some embodiments of the present invention will be described in detail with reference to the accompanying drawings. Note that the same or similar components in the drawings are designated by the same reference numerals as far as possible even if they are shown in different drawings. In the following description of the present invention, a detailed description of known functions and configurations incorporated herein will be omitted to avoid making the subject matter of the present invention unclear.

The terms such as “first”, “second”, “A”, “B”, “(a)”, and “(b)”, may be used to describe of elements according to an embodiment of the present invention. However, since the terms are used only to distinguish an element from another, the essence, sequence, and order of the elements are not limited by them. When it is described that an element is “coupled to”, “engaged with”, or “connected to” another element, it should be understood that the element may be directly coupled or connected to the other element but still another element may be “coupled to”, “engaged with”, or “connected to” the other element between them.

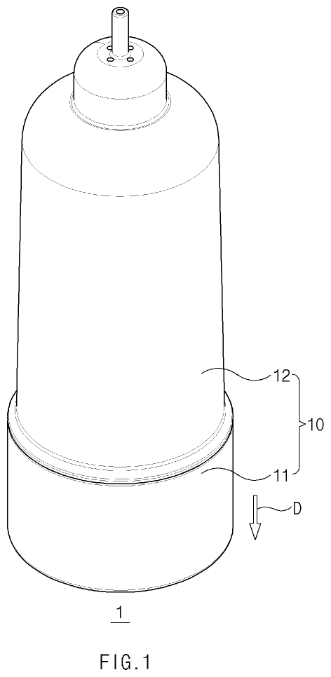

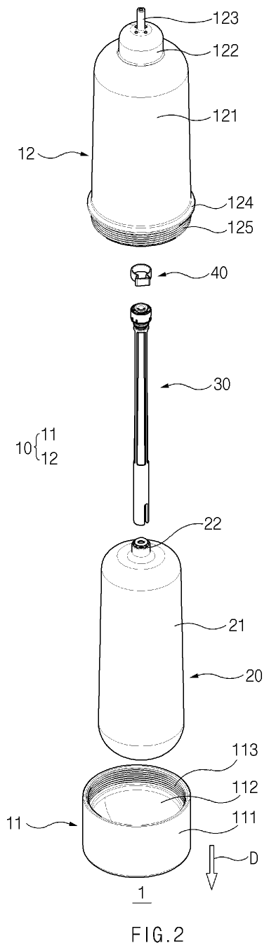

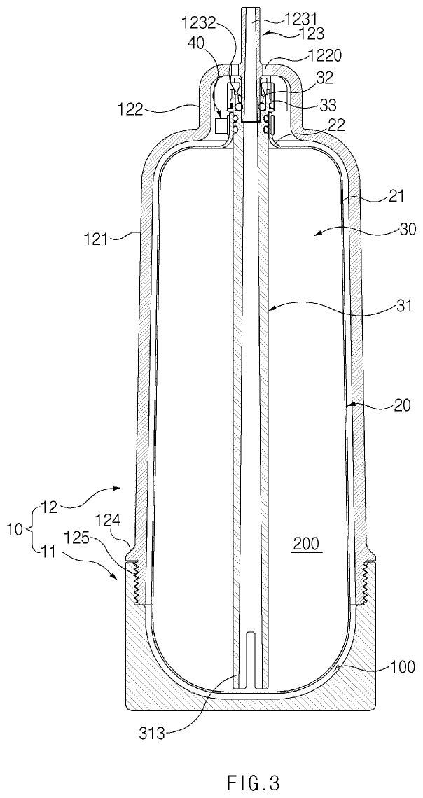

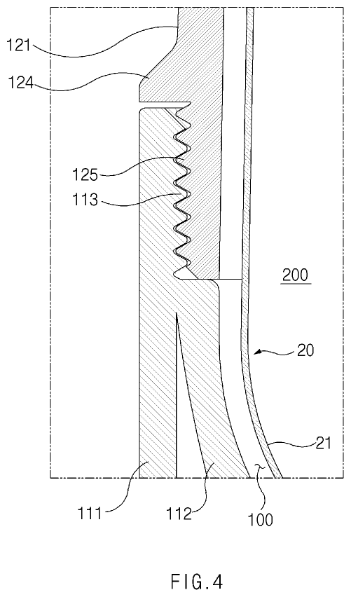

FIG. 1 is a perspective view of a flexible tank 1 according to an embodiment of the present invention. FIG. 2 is an exploded perspective view of the flexible tank 1 according to an embodiment of the present invention. FIG. 3 is a longitudinal cross-sectional view of the flexible tank 1 according to an embodiment of the present invention. FIG. 4 is an enlarged detailed view of a portion in FIG. 3.

Referring to the drawings, the flexible tank 1 according to an embodiment of the present invention includes an inner tank 20, an outer tank 10, and a passage part 30. The flexible tank 1 may include a clamp 40. In the present disclosure, a reference direction D means a downward direction, and an end in the reference direction D means a lower end. However, this is for convenience of explanation, and the reference direction D may be changed according to a direction in which the flexible tank 1 is disposed.

Inner Tank (20)

The inner tank 20 has an inner space 200 and has elasticity. Accordingly, the inner tank 20 may expand or contract, and the inner space 200 may have a size that changes as the inner tank 20 expands or contracts. As water is introduced into the inner space 200, the inner tank 20 may expand, and as the water is discharged from the inner space 200, the inner tank 20 may contract.

The inner tank 20 may be made of a soft material capable of expanding and contracting according to the introduction of a fluid into the inner space 200 and the discharge of the fluid from the inner space 200, respectively. For example, the inner tank 20 may be made of polyolefin elastomer (POE). However, the inner tank 20 may have an expandable structure, even though the inner tank is not made of a soft material. For example, the inner tank 20 may have a corrugated tube or bellows structure. However, the material and the structure of the inner tank 20 are not limited thereto as long as the inner tank 20 has elasticity.

The inner tank 20 may have a shape extending vertically. The inner tank 20 may have a lower end having a curved surface, and a middle portion that is a tank body part 21 having a cylindrical shape extending vertically. The inner tank 20 may have an upper end in which a tank inlet part 22 coupled to the passage part 30 is disposed.

Outer Tank (10)

The inner tank 20 is disposed inside the outer tank 10. The outer tank 10 may surround the inner tank 20 to limit the inner space 20 of the inner tank 20. When the inner tank 20 expands to be in contact with the outer tank 10, the expansion is restricted by the outer tank 10 so that the inner tank 20 does not expand to have a larger volume than that of the outer tank 10. The outer tank 10 may be made of a hard material so that the outer tank 10 does not expand or contract due to the inflow and outflow of a fluid. The outer tank 10 may have a shape extending vertically.

The outer tank 10 may include an outer base part 11 and an outer cover 12. In a state in which the inner tank 20 is coupled to the outer cover 12, the outer base part 11 may cover a lower side of the outer cover 12 and be coupled thereto, so that the outer base part 11 and the outer cover 12 surround the inner tank 20 together. For this coupling, the outer base part 11 may be provided with a base coupling part 113, and the outer cover 12 may be provided with a cover coupling part 125 so that the base coupling part 113 and the cover coupling part 125 are detachably coupled to each other. The base coupling part 113 and the cover coupling part 125 may have threads engaged with each other to be screw-coupled to each other.

Respective portions of the outer tank 10 and the inner tank 20 may be fixed to be spaced apart from each other so that an interspace 100 is defined between the outer tank 10 and the inner tank 20 in a state in which the inner tank 20 is not filled with water and is thus not maximally expanded. The outer cover 12 may include a cover body 121 and a cover inlet part 122 disposed on an upper end of the cover body 121. The tank inlet part 22 of the inner tank 20 may be coupled to the cover inlet part 122. The tank inlet part 22 may be coupled to the cover inlet part 122 by means of the passage part 30. An inner surface of the cover body 121 may be separated from an outer surface of the inner tank 20, and the outer surface of the inner tank 20 may be separated from an inner surface of a base body 112 of the outer base part 11, which will be described later. The interspace 100 may be defined in this separated space. The cover body 121, the cover inlet part 122, and the base body 112, which surround the inner tank 20, may constitute a case part. As the inner tank 20 is filled with water and expands, the interspace 100 may disappear, and as the water is discharged from the inner tank 20 and the inner tank 20 contracts, the interspace 100 may be defined again.

The cover inlet part 122 may have a shape protruding upward from an upper end of the cover body 121. The outer cover 12 may include a mouth part 123. The mouth part 123 is provided in the form of a pipe of which the inside is penetrated, and thus has a structure through which water is introduced and discharged. The mouth part 123 may extend vertically and be penetrated vertically. The mouth part 123 may pass through the cover inlet part 122. The mouth part 123 may have an inner end 1232, which is disposed inside a space surrounded by the outer cover 12, and an outer end 1231 which is disposed outside the space surrounded by the outer cover 12. The outer end 1231 of the mouth part 123 may be connected to a water pipe, and receive water to transfer the water to the inner tank 20, or transfer the water discharged from the inner tank 20 to the water pipe.

A tank hole 1220 may be defined in the cover inlet part 122. The tank hole 1220 may be provided to pass through the cover inlet part 122 vertically. The interspace 100 may communicate with the outside of the outer tank 10 through the tank hole 1220. Thus, the pressure of the interspace 100 may be adjusted to be the same as the external pressure through the tank hole 1220, and thus the expansion or contraction of the inner tank 20 may occur when the fluid is introduced into or discharged from the inner tank 20.

The tank hole 1220 may be provided in plurality. A plurality of tank holes 1220 may be disposed to surround the mouth part 123 and be spaced apart from each other. The tank hole 1220 may be defined in a position at which the passage part 30 is observable through the tank hole 1220 when the tank hole 1220 is viewed from the outside of the outer tank 10. The passage part 30 may be checked through the tank hole 1220 when the tank hole 1220 is viewed in the downward direction.

A cover hooking part 124 may be provided to protrude outward from the cover body 121 above the cover coupling part 125 of the outer cover 12. The cover hooking part 124 may be provided above the base coupling part 113 to cover a boundary between the base coupling part 113 and the cover coupling part 125 and to prevent the base coupling part 113 from moving further upward. The cover hooking part 124 may have an outer surface inclined toward the outside in the downward direction.

The outer base part 11 may include the base body 112, and a base support 111 surrounding the base body 112. The base body 112 may be provided to have an inner surface having a curved surface shape so as to correspond to the shape of the lower end of the inner tank 20, and surround the lower end of the inner tank 20. The base support 111 may be connected to a circumference of the base body 112, and have a cylindrical shape extending vertically so that the base support 111 stably stands the flexible tank 1 when the flexible tank 1 is seated in a housing of a water purifier, or the like.

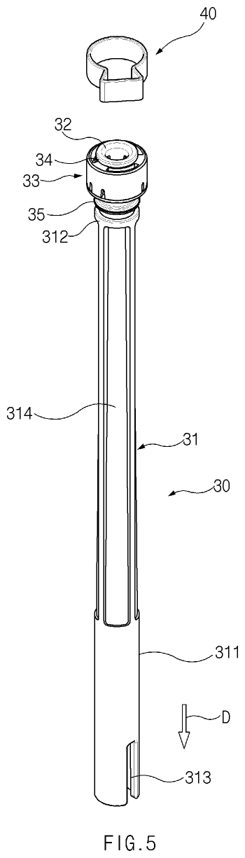

FIG. 5 is a perspective view of the clamp 40 and the passage part 30 according to an embodiment of the present invention.

Clamp (40)

The clamp 40 may clamp the tank inlet part 22 of the inner tank 20 and the passage part 30 to fix the inner tank 20 and the passage part 30, and to prevent water from leaking between the tank inlet part 22 and the passage part 30. The clamp 40 may be made of a metal material, particularly stainless steel (SUS), to clamp the inner tank 20 and the passage part 30 due to the elastic force of the material. However, the clamp 40 may also have a structure for selectively performing clamping and releasing operations.

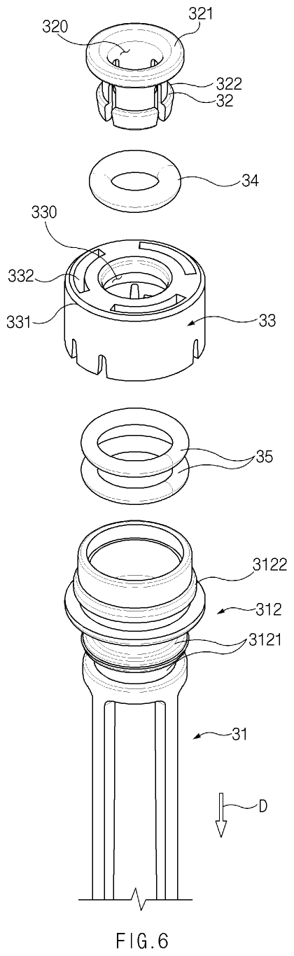

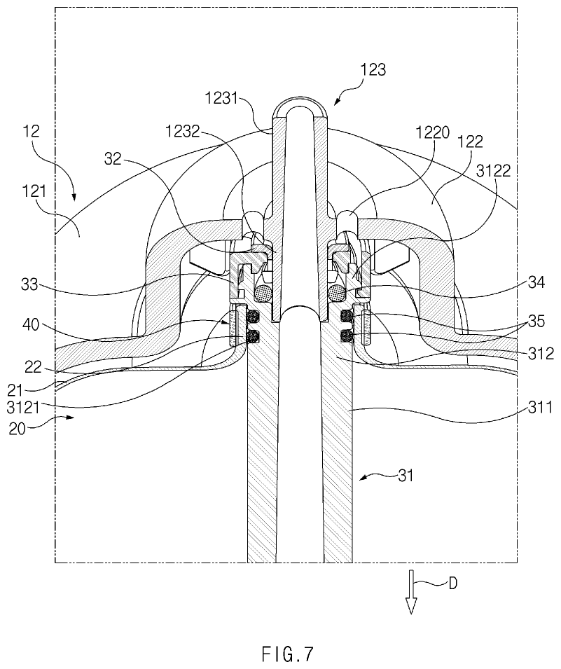

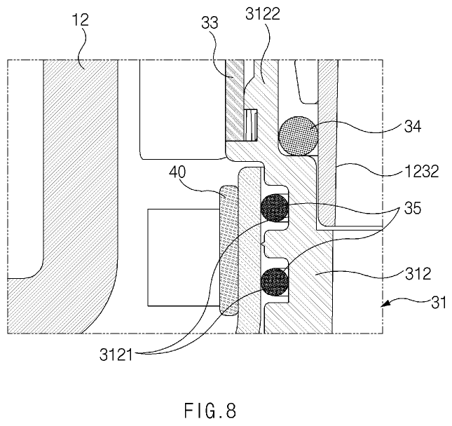

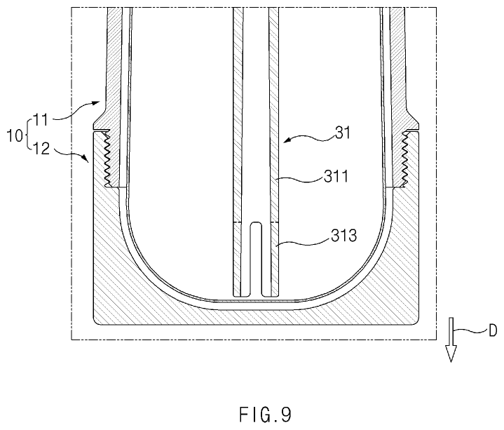

FIG. 6 is an exploded perspective view of the passage part 30 according to an embodiment of the present invention. FIG. 7 is a view illustrating an upper portion of the flexible tank 1 so as to expose a longitudinal section of the flexible tank 1 according to an embodiment of the present invention. FIG. 8 is an enlarged detailed view of another portion in FIG. 3. FIG. 9 is an enlarged detailed view of still another portion in FIG. 3.

Passage Part (30)

The passage part 30 is a component that passes through the inner tank 20, and has an outer end disposed outside the inner tank 20 and an inner end disposed in the inner space 200 so that the inner space 200 communicates with the outside of the inner tank 20. Water may be introduced into the inner space 200 or discharged from the inner space 200 to the outside through the passage part 30. Thus, the passage part 30 as a whole is vertically penetrated to provide a passage.

The passage part 30 may have a lower end that is disposed to be adjacent to the lower end of the inner tank 20. The passage part 30 may include a passage body part 31 having a pipe shape extending vertically, and a lower end of the passage body part 31 serves as the lower end of the passage part 30. The passage body part 31 may be recessed to define a passage slit 313 in the lower end of the passage part 30. The passage slit 313 may extend vertically, i.e., in a direction in which the passage part 30 extends, and may be provided in plurality so that a plurality of passage slits 313 are disposed to be spaced apart from each other along a circumference of the passage body part 31. As the passage slit 313 is defined, water may be introduced into the inner tank 20 or discharged from the inner tank 20 through the passage body part 31 even when the lower end of the passage body part 31 is in contact with a bottom surface of inner surfaces of the inner tank 20. A vertical length of a passage middle body 311, which is a portion in which the passage slit 313 is not defined, may be greater than a length of the passage slit 313. This is because when the passage slit 313 is excessively long, a case may occur in which water introduced later is first discharged in a state in which the water is not properly mixed in the inner space 200.

A middle portion in a longitudinal direction of the passage middle body 311 may have a passage body recessed portion 314 in the longitudinal direction so that the passage part 30 is reduced in weight. The passage body recessed portion 314 may be provided in plurality to be spaced apart from each other.

The passage body part 31 may have an upper end that is connected to the mouth part 123. A mouth coupling part 3122, which is included in a passage coupling part 312 provided on the upper end of the passage body part 31, may be coupled to the mouth part 123 while covering the mouth part 123. As the inner tank 20 is coupled to the passage part 30 through a tank coupling part 3121 to be described later, the inner tank 20 and the outer tank 10 may be coupled to each other by means of the passage part 30.

The passage part 30 may include a passage O-ring 34 disposed between the mouth part 123 and the mouth coupling part 3122 so as to maintain watertightness between the mouth part 123 and the passage body part 31. The passage O-ring 34 may be made of a material having elasticity and have an annular shape to surround the inner end 1232 of the mouth part 123. The passage O-ring 34 may be interposed between an outer surface of the mouth part 123 and an inner surface of the mouth coupling part 3122.

The tank coupling part 3121 included in the passage coupling part 312 may be provided below the mouth coupling part 3122. The passage part 30 may include two tank O-rings 35 disposed between the passage body part 31 and the inner tank 20 so as to maintain watertightness between the passage body part 31 and the inner tank 20. The tank coupling part 3121 may have a shape of a groove recessed to the inside so that each of the tank O-rings 35 is insertable into the groove. The two tank O-rings 35 may be disposed to be spaced apart from each other vertically. The two tank O-ring 35 may be made of a material having elasticity and have an annular shape to surround the tank coupling part 3121. The tank O-ring 35 may be interposed between an outer surface of the tank coupling part 3121 and an inner surface of the tank inlet part of the inner tank 20. As the tank O-ring 35 is provided in two, the watertightness at a boundary at which each of the tank O-rings 35 is disposed may be better maintained.

The passage part 30 may include a fitting 32. The fitting 32 may be used to stably couple the mouth part 123 and the passage body part 31 to each other. The fitting 32 may be inserted into the mouth coupling part 3122 and coupled to the mouth coupling part 3122. The fitting 32 may include a fitting base part 321 having an annular shape, which is disposed above the mouth coupling part 3122 and defines a fitting hole 320 into which the mouth part 123 is inserted, and a fitting coupling part 322 which extends downward from the fitting base part 321 and is inserted into the mouth coupling part 3122 and snap-fit coupled to a structure of the inner surface of the mouth coupling part 3122. The fitting base part 321 may have an inner surface of which a cross-sectional area gradually decreases downward on a cross section taken along a plane perpendicularly crossing an upward and downward direction. Accordingly, when the mouth part 123 is inserted through the fitting hole 320, the mouth part 123 may be guided to a proper position to be easily coupled to the mouth coupling part 3122.

The fitting 32 may be disposed above the passage O-ring 34. The fitting 32 may be disposed below the tank hole 1220. The fitting 32 may be observable through the tank hole 1220 when the tank hole 1220 is viewed in the downward direction. Thus, when being separated from each other, the outer tank 10 and the inner tank 20 may be easily separated using a method in which a tool is inserted through the tank hole 1220 to push the fitting 32.

The passage part 30 may include an end cap 33. The end cap 33 may be disposed to couple the passage body part 31 and the cover inlet part 122 of the outer tank 10. In a state in which the end cap 33 is coupled to an outer surface of the mouth coupling part 3122, the end cap 33 may be inserted into and coupled to an inner surface of the cover inlet part 122. Accordingly, the inner tank 20 and the outer tank 10 may be coupled to each other by means of the passage part 30. The end cap 33 may include a cap body 331 having an annular shape, and a cap hole 330 that is vertically penetrated may be defined in a center of the cap body 331. The cap body 331 may have a lower end that is snap-fit coupled to the outer surface of the mouth coupling part 3122. A plurality of circumferential holes 332 that surround the cap hole 330 and are vertically penetrated may be defined and disposed to avoid undercut.

As described above, as the flexible tank 1 including the inner tank 20 having elasticity is provided, the inlet and outlet for the water may be unified into the passage part 30 and the mouth part 123, and portions for inflow and outflow of air may not be further required so that sealing of the inner space 200 is enabled. Accordingly, various structures, in which trouble caused by introduction of dust, etc. does not occur and which are capable of preventing water leakage, may be applicable to improve the performance of preventing water leakage. Moreover, as the outer tank 10 made of a soft material is disposed, a threshold volume at which the inner tank 20 is capable of expanding may be easily set. Accordingly, when the water accommodated in the inner space 200 approaches a full water level, whether to reach the full water level may be detected through a pressure sensor of a pump connected to the flexible tank 1, without a need to separately dispose a water level sensor in the flexible tank 1.

Accordingly, the flexible tank sealed by including the inner tank having the elasticity may be provided.

Although all of the components constituting the embodiments of the present invention are described to be combined as one unit or to operate as a combination thereof, the present invention is not necessarily limited to these embodiments. That is, within the scope of the present invention, all of the components may be selectively combined to one or more thereof to operate as a combination. The term such as “comprising,” “configure”, or “having”, specifies the presence of components, unless there is a clearly different meaning in the present disclosure, but do not preclude the presence thereof and should be construed to further include other components. Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The description of the present invention is intended to be illustrative, and various changes and modifications can be made by those of ordinary skill in the art to which the present invention pertains, without departing from the spirit and scope of the present invention as defined by the appended claims. Therefore, the embodiments set forth herein are to describe the technical spirit of the present invention and not to limit. The scope of the technical spirit of the present invention is not limited by the embodiments. Moreover, the protective scope of the present invention should be determined by reasonable interpretation of the appended claims and all technical concepts coming within the equivalency range of the present application should be interpreted to be in the scope of the right of the present application.

What is claimed is:

1. A flexible tank comprising:
an inner tank having an inner space and having elasticity;
an outer tank in which the inner tank is disposed; and
a passage part passing through the inner tank in a reference direction, and having an outer end disposed outside the inner tank and an inner end disposed in the inner space so that the inner space communicates with the outside of the inner tank.

2. The flexible tank of claim 1, wherein the outer tank comprises:
an outer base part; and
an outer cover configured to surround the inner tank together with the outer base part, and detachably coupled to the outer base part.

3. The flexible tank of claim 1, wherein respective portions of the outer tank and the inner tank are fixed to be spaced apart from each other so that an interspace is defined in a state in which the inner tank is not maximally expanded.

4. The flexible tank of claim 3, wherein a tank hole through which the interspace communicates with the outside of the outer tank is defined in the outer tank.

5. The flexible tank of claim 4, wherein the tank hole is provided in a position at which the passage part is observable through the tank hole when the tank hole is viewed from the outside of the outer tank.

6. The flexible tank of claim 1, wherein an end of the passage part in the reference direction is disposed to be adjacent to an end of the inner tank in the reference direction,
wherein the passage part is recessed to define a passage slit in the end of the passage part in the reference direction,
wherein the passage slit extends in a direction in which the passage part extends.

7. The flexible tank of claim 1, wherein the outer tank comprises:
a case part configured to surround the inner tank; and
a mouth part passing through the case part,
wherein the passage part comprises:
a passage body part connected to the mouth part; and
a passage O-ring disposed between the mouth part and the passage body part so as to maintain watertightness between the mouth part and the passage body part.

8. The flexible tank of claim 1, wherein the passage part comprises:
a passage body part connected to the mouth part; and
two tank O-rings disposed between the passage body part and the inner tank so as to maintain watertightness between the passage body part and the inner tank.

9. The flexible tank of claim 1, wherein each of the outer tank and the inner tank has a shape extending in the reference direction, and
an end of the inner tank in the reference direction has a curved surface.
